(19) United States
(12) Patent Application Publication
(10) Pub. No.: US 2006/0076151 A1
(43) Pub. Date: Apr. 13, 2006

(54) Sprinkler head cleaner

(76) Inventor: Michael Barham, Vero Beach, FL (US)

Correspondence Address: JAMES RAY & ASSOCIATES, 2640 PITCAIRN ROAD, MONROEVILLE, PA, 15146, US

(21) Appl. No.: 11/059,154

(22) Filed: Feb. 16, 2005

Related U.S. Application Data
(60) Provisional application No. 60/617,926, filed on Oct. 12, 2004.

(51) Int. Cl. A01D 15/00

(52) U.S. Cl. 172/13

(57) ABSTRACT

A device for trimming around sprinkler heads which is engageable with a line trimmer. The device has a predetermined size and comprises a cylindrical dome shaped member having a substantially flat upper surface portion for engagement with such line trimmer. Such cylindrical dome shaped member has a plurality of grooves, which have a predetermined shape, formed in a wall portion which extends from the flat upper surface portion of such cylindrical dome shaped member for a predetermined distance and a means engageable with the device for securing the cylindrical dome shaped member to such line trimmer.

### CROSS REFERENCE TO RELATED APPLICATIONS

This application is closely related to and claims benefit from U.S. Provisional Application Ser. No. 60/617,926 filed Oct. 12, 2004.

### FIELD OF THE INVENTION

The present invention relates, in general, to a line trimming apparatus, and, more particularly, the present invention relates to a device used with line trimming apparatus which cleans grass and dirt from around a sprinkler head.

### BACKGROUND OF THE INVENTION

Many people have a sprinkler system installed in a lawn. Such sprinkler systems, in many instances, have sprinkler heads in the ground. One major problem with these sprinkler heads is that grass, dirt and other debris often accumulates around the in-ground sprinkler head. If this grass or debris is allowed to grow around the sprinkler head, the sprinklers themselves may not work properly. A sprinkler system is an expensive addition to any home and it must be maintained to avoid costly repairs. Cleaning around the sprinkler head can be quite a chore because there isn't anything which does a satisfactory job without considerable care. Thus, there is a need for a device to aid in the removal of such debris and grass that has grown around the sprinkler head.

### SUMMARY OF THE INVENTION

In a first aspect the present invention provides a device for trimming around sprinkler heads. The device is engageable with a line trimmer. The device, having a predetermined size, comprises a cylindrical dome shaped member having a substantially flat upper surface portion for engagement with such line trimmer. Such cylindrical dome shaped member has a plurality of grooves, which have a predetermined shape, formed in a wall that extends from the flat upper surface portion of the cylindrical dome shaped member for a predetermined distance and a means engageable with the device for securing the cylindrical dome shaped member to such line trimmer.

### OBJECTS OF THE INVENTION

It is, therefore, one of the primary objects of the present invention to provide a device which can attach to the head of line trimmer which will easily clean the area around an in-ground sprinkler head.

Another object of the present invention is to provide a device which is easily attachable to the line trimmer.

Yet, another object of the present invention is to provide a device which cleans the area around such sprinkler head quickly, cleanly and efficiently.

Still another object of the present invention is to provide a device for cleaning around a sprinkler head which is relatively inexpensive to manufacture.

Another object of the present invention is to provide a device for cleaning around a sprinkler head which can also be used to dig holes in the ground.

It is another object of the present invention to provide a device for cleaning around a sprinkler head which will also loosen soil and remove small roots.

In addition to the various objects and advantages of the invention which have been described in some specific detail above it should be noted that various other objects and advantages of the present invention will become more readily apparent to those persons who are skilled in the relevant art from the following more detailed description, particularly, when such description is taken in conjunction with the attached drawing FIGS. and with the appended claims.

### BRIEF DESCRIPTION OF THE DRAWINGS

FIG. 1 is a partial perspective view of the top of the sprinkler head cleaner according to an embodiment of the invention.

FIG. 2 is a partial perspective view of the underside of the sprinkler head cleaner shown in FIG. 1.

FIG. 3 is a partial perspective view of the sprinkler head cleaner attached to a line trimmer.

FIG. 4 is a partial perspective view of the bottom of the line trimmer and the sprinkler head cleaner shown in FIG. 1 showing the mounting arrangement.

### BRIEF DESCRIPTION OF THE PRESENTLY PREFERRED AND VARIOUS ALTERNATIVE EMBODIMENTS OF THE INVENTION

Prior to proceeding to the more detailed description of the invention, it should be noted that identical components having identical functions have been designated with identical reference numerals throughout the several views illustrated in the drawings for the sake of clarity.

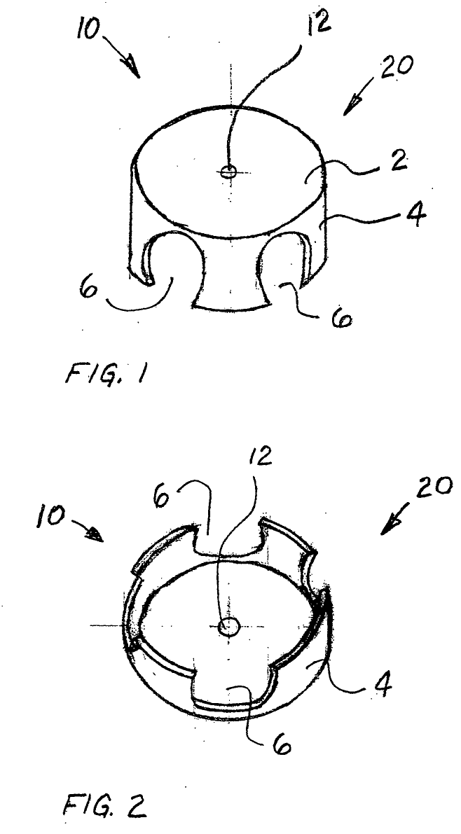

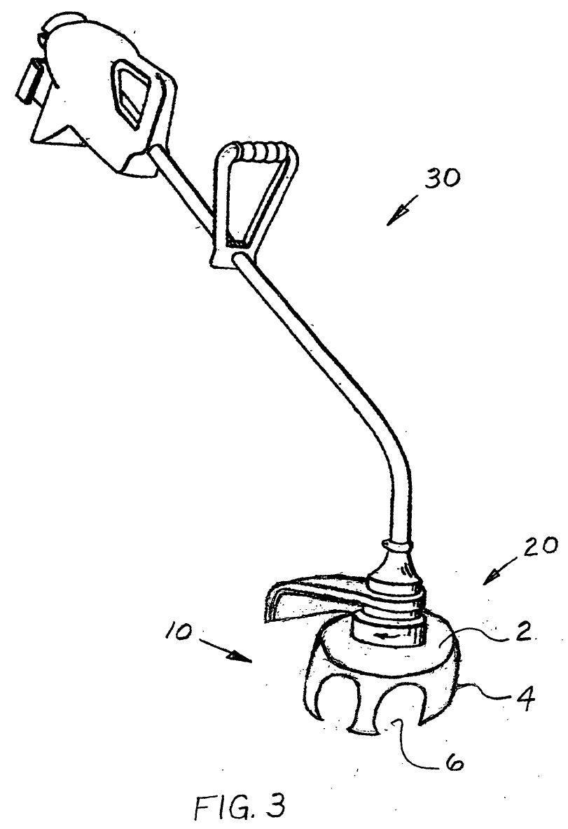

Now reference is made, more particularly, to drawing FIGS. 1 and 2. Illustrated therein is a device, generally designated 10, for cleaning around a sprinkler head. Such device 10 has a predetermined size. Such device 10 comprises a cylindrical dome shaped member, generally designated 20. The cylindrical dome shaped member 20 has a substantially flat upper surface portion 2 which engages a line trimmer, generally designated 30, which is evident in drawing FIG. 3. There is a wall portion 4 which extrends from such flat upper surface portion 2 of the cylindrical dome shaped member 20 for a predetermined distance. Such wall 4 has a plurality of grooves 6 formed therein. As is evident in FIGS. 1 and 2 the grooves 6 are generally circular; however, they are truncated at the end away from the flat upper surface portion 2 so that they are generally horseshoe shaped. The generally horseshoe shaped grooves 6 are open at the bottom which provides the cutting area when the apparatus 10 is in use. It is presently preferred that such plurality of generally horseshoe shaped grooves 6 is four. It is also presently preferred that such plurality of four generally horseshoe shaped grooves 6 are spaced equidistant around the wall 4 of the cylindrical shaped dome member 20 so the wall 4 is substantially symmetrical. It is also a preferred embodiment of the invention that such generally horseshoe shaped grooves 6 have a relatively sharp edge.

Such substantially flat upper surface 2 of such cylindrical dome shaped member 20 has an aperture 12 disposed substantially in the center of the substantially flat upper surface 2.

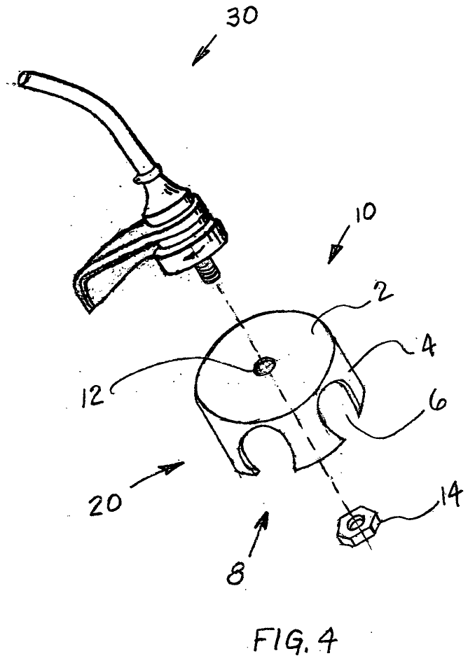

Such device 10 further includes a means 8 for securing such device 10 to a line trimmer 30. In attaching such device 10 to a line trimmer 30, the first step is the removal of the spring-spool member of the line trimmer(not shown). Once the spring-spool member is removed then it is easy to attach the device 10 to the line trimmer 30. The device 10 engages the bolt of the line trimmer with the aperture 12 in the substantially flat upper surface 2 and the device 10 is then secured to the line trimmer by means of a nut 14. It is presently preferred that such nut 14 is a reverse thread nut. The means 8 for attaching the device 10 to the line trimmer is illustrated in FIG. 4.

The predetermined size of the device 10 is one of three inches, four inches and six inches. These would correspond to the common sizes that are used in sprinkler heads. Thus, the device 10 would have sufficient clearance to cut around the sprinkler head, yet be close enough that grass and other debris would be removed very close to the sprinkler head. It is also presently preferred that such predetermined distance that such wall 4 extends downward from such substantially flat upper surface portion 2 is between about 1 inch and about 3 inches.

Such device 10 is made of one of metal, plastic and ceramic. It is presently preferred that such device 10 be made of plastic.

Such device 10 can also be used for removing a plug from the ground or essentially digging a circular hole in the ground. The plug would be substantially the diameter of the device.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. A device for trimming around sprinkler heads engageable with a line trimmer, said device having a predetermined size, said device comprising:
(a) a cylindrical dome shaped member having a substantially flat upper surface portion for engagement with such line trimmer, said cylindrical dome shaped member having a plurality of grooves having a predetermined shape formed in a wall extending from said flat upper surface portion of said cylindrical dome shaped member for a predetermined distance; and
(b) a means engageable with said device for securing said cylindrical dome shaped member to such line trimmer.

2. The device, according to claim 1, wherein said predetermined shape of said plurality of grooves formed in said wall of said cylindrical dome shaped member are generally horseshoe shaped.

3. The device, according to claim 2, wherein said plurality of generally horseshoe shaped grooves formed in said wall of said dome shaped member is four.

4. The device, according to claim 3, wherein said plurality of generally horseshoe shaped grooves formed in said wall of said cylindrical dome are disposed substantially equidistant on said wall of said cylindrical dome shaped member.

5. The device, according to claim 2, wherein said plurality of generally horseshoe shaped grooves are for cutting grass.

6. The device, according to claim 5, wherein said generally horseshoe shaped grooves include a sharp edge.

7. The device, according to claim 1, wherein said means for securing said cylindrical dome shaped member to such line trimmer is a nut.

8. The device, according to claim 6, wherein said nut is a reverse thread nut.

9. The device, according to claim 1, wherein said predetermined size of said device substantially corresponds to conventional sizes of such sprinkler heads.

10. The device, according to claim 9, wherein said predetermined size of said device is one of about three inches, about four inches and about six inches.

11. The device, according to claim 1, wherein said device is made of one of plastic, metal and ceramic.

12. The device, according to claim 11, wherein said device is made of plastic.

13. The device, according to claim 1, wherein said side of said cylindrical dome shaped member has a predetermined depth.

14. The device, according to claim 1, wherein said dome shaped member has a centrally disposed aperture.

15. The device, according to claim 14, wherein said centrally disposed aperture is for engagement with a bolt of such line trimmer.

16. The device, according to claim 1, wherein said predetermined distance is between about 1 inch and about 3 inches.

17. A device engageable with a line trimmer for removing a plug from one of a lawn and a ground surface, said device having a predetermined size, said device comprising:
(a) a cylindrical dome shaped member having a substantially flat upper surface portion for engagement with such line trimmer, said cylindrical dome shaped member having a plurality of openings having a predetermined shape formed in a wall extending from said flat upper surface portion of said cylindrical dome shaped member for a predetermined distance; and
(b) a means engageable with said device for securing said cylindrical dome shaped member to such line trimmer.

18. The device, according to claim 17, wherein such plug removed from one of such lawn and ground surface has a predetermined diameter.

19. The device, according to claim 18, wherein such predetermined diameter is substantially one of 3 inches, 4 inches and 6 inches.
